(19) United States
(12) Patent Application Publication
(10) Pub. No.: US 2008/0123740 A1
(43) Pub. Date: May 29, 2008

(54) Video De-Noising Algorithm Using Inband Motion-Compensated Temporal Filtering

(76) Inventor: Jong C. Ye, Daejeon (KR)

Correspondence Address: PHILIPS INTELLECTUAL PROPERTY & STANDARDS, P.O. BOX 3001, BRIARCLIFF MANOR, NY, 10510, US

(21) Appl. No.: 10/573,085

(22) PCT Filed: Sep. 21, 2004
(86) PCT No.: PCT/IB04/51813

§ 371 Date: Mar. 23, 2006

Related U.S. Application Data
(60) Provisional application No. 60/505,232, filed on Sep. 23, 2003.

(51) Int. Cl. H04B 1/66

(52) U.S. Cl. 375/240.11; 375/E07.031

(57) ABSTRACT

Method for de-noising video signals in which a wavelet transformer (12) spatially transforms each frame of a video sequence into two-dimensional bands which are subsequently decomposed in a temporal direction to form spatial-temporal sub-bands. The spatial transformation may involve the application of a low band shifting method to generate shift-invariant motion reference frames. The decomposition of the two-dimensional band may involve the use of motion-compensated temporal filters (16), one for each two-dimensional band. Additive noise is then eliminated from each spatial-temporal sub-band, for example, using a wavelet de-noising technique such as soft-thresholding, hard-thresholding and a wavelet wiener filter.

### CROSS REFERENCE TO RELATED APPLICATION

This application claims the benefit of U.S. provisional application Ser. No. 60/505,232 filed Sep. 23, 2003, which is incorporated herein by reference.

The present invention relates generally to techniques for removing noise from video streams (de-noising) and more specifically to techniques for denoising video streams using inband motion-compensated temporal filtering (IBMCTF).

Video streams invariably contain an element of noise which degrades the quality of the video. One way to eliminate noise from video signals and other signals is to use wave transformation. Wavelet transformation involves the decomposition of information contained in a signal into characteristics of different scales. When the signal is seen in the wavelet domain, its representation is apparent by large coefficients while the undesired signal (noise) will be represented by much smaller coefficients and often will be equally distributed across all of the wavelet decomposition scales.

To separate and remove the noise from the desired signal, it is known to use wavelet thresholding in the wavelet domain. A basic principle of wavelet thresholding is to identify and zero out wavelet coefficients of a signal which are likely to contain mostly noise thereby preserving the most significant coefficient(s). By preserving the most significant coefficient(s), wavelet thresholding preserves important high-pass features of a signal, such as discontinuities. This property is useful, for example, in image de-noising to maintain the sharpness of the edges in an image.

The method of wavelet thresholding for de-noising has been researched extensively due to its effectiveness and simplicity. It has been shown that a wavelet thresholding estimator achieves near mini-max optimal risk for piecewise smooth signals such as still images.

While the wavelet denoising technique has been extensively investigated in still image cases, only a limited amount of research has been conducted for its application for video de-noising. Noise reduction for digital videos is even more important than in the conventional analog representation because today's consumer has come to expect high quality from anything digital.

A conventional technique for video de-noising is based on a three-step approach: (1) obtain a spatially de-noised estimate; (2) obtain a temporally de-noised estimate; and (3) combine the two estimates to obtain a final de-noised estimate. For the spatial de-noised estimate, wavelet thresholding and/or one or more wavelet domain wiener filter techniques are used. For the temporal de-noised estimate, a linear filtering approach using a Kalman filter may be employed. After the two independently obtained de-noised estimates are created, several combining schemes have been investigated.

A drawback of the conventional video de-noising techniques is that noise variance is assumed to be known which limits its applicability in practice.

It is an object of the present invention to provide new and improved video de-noising methods and equipment.

It is another object of the present invention to provide new and improved techniques for de-noising video using inband motion-compensated temporal filtering (IBMCTF) and equipment.

In order to achieve these objects and others, a method for de-noising video signals in accordance with the invention includes the steps of spatially transforming each frame of video sequences into two-dimensional bands, decomposing the two-dimensional bands in a temporal direction to form spatial-temporal sub-bands, for example, by applying a low band shifting method to generate shift-invariant motion reference frames, and then eliminating additive noise from each spatial-temporal sub-band. The decomposition of the two-dimensional band may involve the use of one or more motion-compensated temporal filtering techniques. The elimination of additive noise from each spatial-temporal sub-band may entail using a wavelet de-noising technique such as soft-thresholding, hard-thresholding and a wavelet wiener filter.

In some embodiments, the application of the low band shifting method to generate shift-invariant motion reference frames involves generating a full set of wavelet coefficients for all possible shifts of a low-low sub-band, and optionally storing the wavelet coefficients by interleaving the wavelet coefficients such that new coordinates in an overcomplete domain correspond to an associated shift in the original spatial domain. The wavelet coefficients can be interleaved at each decomposition level.

As an example of equipment which applies the de-noising algorithm, a video encoder in accordance with the invention would include a wavelet transformer for receiving uncompressed video frames from a source thereof and transforming the frames from a spatial domain to a wavelet domain in which two-dimensional bands are represented by a set of wavelet coefficients, software or hardware which breaks the bands into groups of frames, motion compensated temporal filters, each receiving the group of frames of a respective band and temporally filtering the band to remove temporal correlation between the frames and software or hardware which texture codes the temporally filtered bands with the texture coded, temporally filtered bands being combined into a bitstream.

More specifically, the wavelet transformer decomposes each frame into a plurality of decomposition levels. For example, a first one of the decomposition levels could include a low-low (LL) band, a low-high (LH) band, a high-low (HL) band, and a high-high (HH) band, whereas a second one of the decomposition levels might include decompositions of the LL band into LLLL (low-low, low-low), LLLH (low-low, low-high), LLHL (low-low, high-low) and LLHH (low-low, high-high) sub-bands.

The decomposition may be in accordance with a low band shifting method in which a full set of wavelet coefficients is generated for all possible shifts of one or more of the input bands to thereby accurately convey any shift in the spatial domain. In this case, the wavelet transformer may generate the full set of wavelet coefficients by shifting the wavelet coefficients of the next-finer level LL band and applying one level wavelet decomposition, the wavelet coefficients generated during the decomposition then being combined to generate the full set of wavelet coefficients. To enhance the removal of noise, the wavelet transformer may be designed to interleave the wavelet coefficients generated during the decomposition in order to generate the full set of wavelet coefficients.

The motion compensated temporal filters are arranged to filter the bands and generate high-pass frames and low-pass frames for each of the bands. Each motion compensated temporal filter includes a motion estimator for generating at least one motion vector and a temporal filter for receiving the motion vector(s) and temporally filtering a group of frames in the motion direction based thereon.

The invention, together with further objects and advantages thereof, may best be understood by reference to the following description taken in conjunction with the accompanying drawings, wherein like reference numerals identify like elements and wherein:

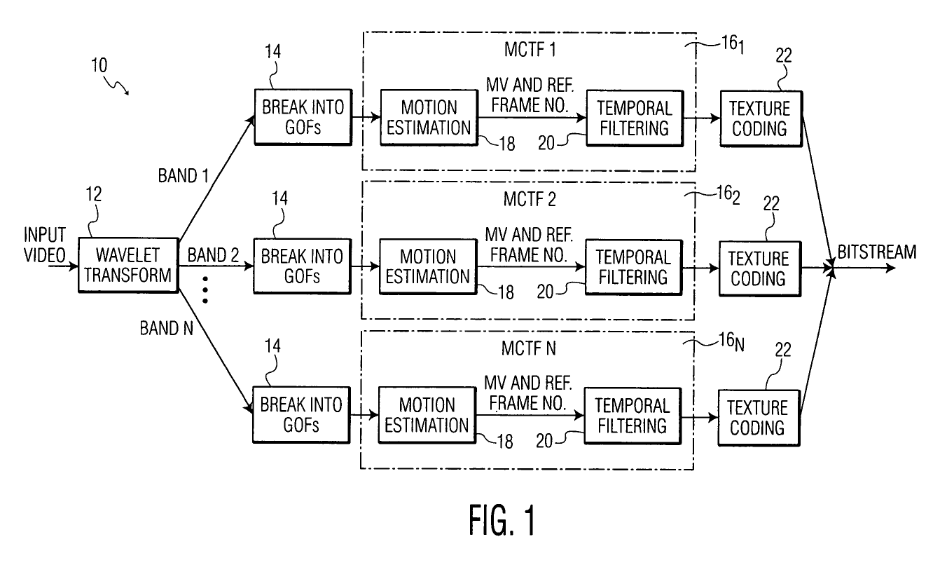

FIG. 1 is a block diagram of a coder applying inband motion-compensated temporal filtering in accordance with the invention.

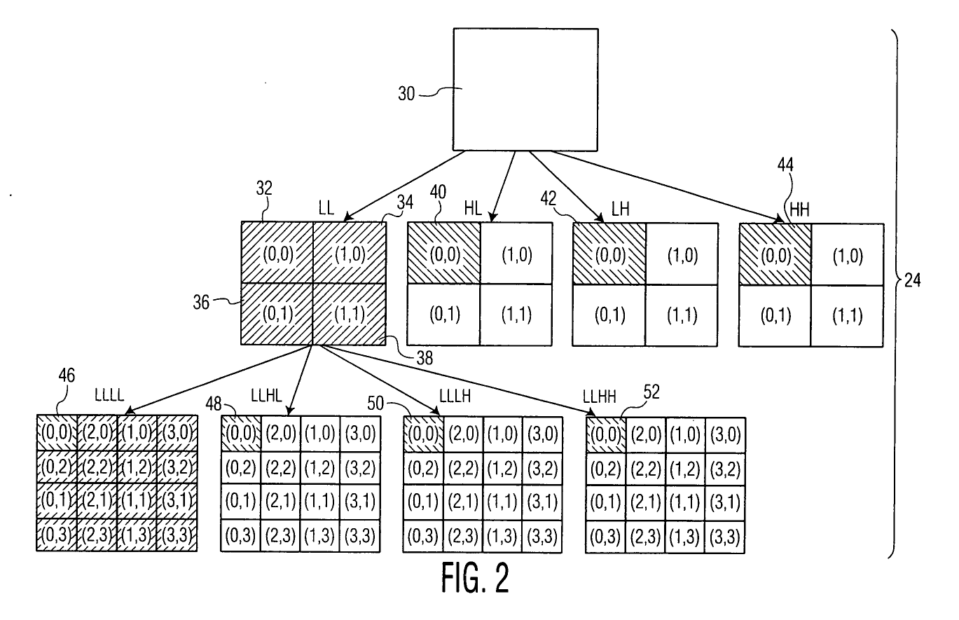

FIG. 2 illustrates overcomplete wavelet expansion using low band shifting method algorithm for two level decomposition in accordance with the invention.

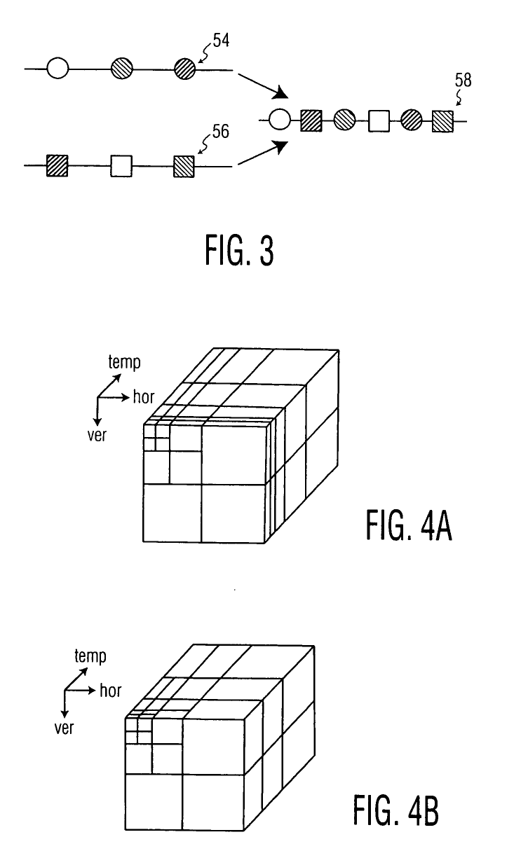

FIG. 3 shows one example of interleaving of overcomplete wavelet coefficients for a one-dimensional decomposition.

FIG. 4A shows a three-dimensional decomposition structure for a separable three-dimensional wavelet.

FIG. 4B shows a three-dimensional decomposition structure for the invention.

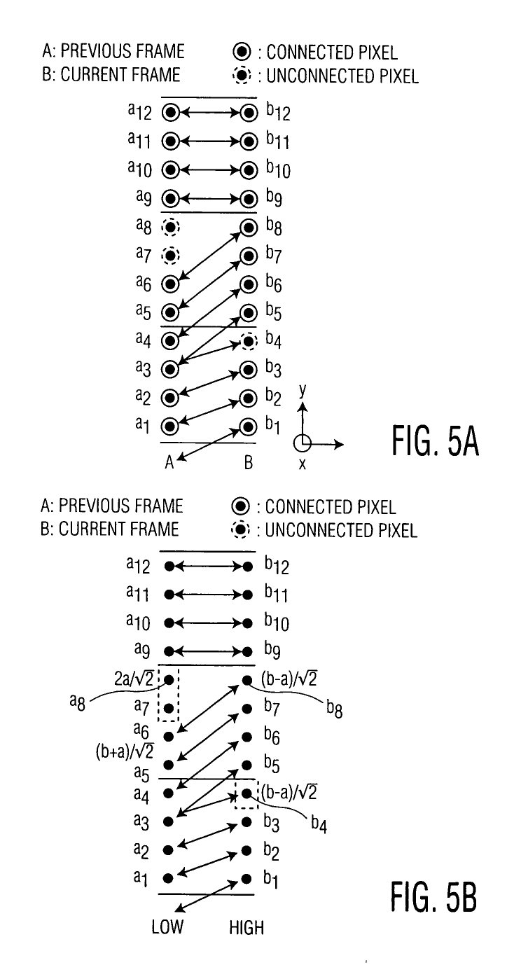

FIGS. 5A and 5B show examples of connected and unconnected pixels.

The de-noising techniques described below may be used in conjunction with any type of video transmission, reception and processing systems and equipment. For the sake of an example only, the invention will be described with reference to a video transmission system including a streaming video transmitter, a streaming video receiver and a data network. The streaming video transmitter streams video information to the streaming video receiver over the network and includes any of a wide variety of sources of video frames, including a data network server, a television station transmitter, a cable network or a desktop personal computer.

Generally, the streaming video transmitter includes a video frame source, a video encoder, an encoder buffer and a memory. The video frame source represents any device or structure capable of generating or otherwise providing a sequence of uncompressed video frames, such as a television antenna and receiver unit, a video cassette player, a video camera or a disk storage device capable of storing a “raw” video clip. The uncompressed video frames enter the video encoder at a given picture rate (or “streaming rate”) and are compressed by the video encoder. The video encoder then transmits the compressed video frames to the encoder buffer. The video encoder preferably employs a denoising algorithm as described below.

The encoder buffer receives the compressed video frames from the video encoder and buffers the video frames in preparation for transmission across the data network. The encoder buffer represents any suitable buffer for storing compressed video frames. The streaming video receiver receives the compressed video frames streamed over the data network by the streaming video transmitter and generally includes a decoder buffer, a video decoder, a video display and a memory. Depending on the application, the streaming video receiver may represent any of a wide variety of video frame receivers, including a television receiver, a desktop personal computer or a video cassette recorder. The decoder buffer stores compressed video frames received over the data network and then transmits the compressed video frames to the video decoder as required.

The video decoder decompresses the video frames that were compressed by the video encoder and then sends the decompressed frames to the video display for presentation. The video decoder preferably employs a denoising algorithm as described below.

The video encoder and decoder may be implemented as software programs executed by a conventional data processor, such as a standard MPEG encoder or decoder. If so, the video encoder and decoder would include computer executable instructions, such as instructions stored in volatile or non-volatile storage and retrieval device or devices, such as a fixed magnetic disk, a removable magnetic disk, a CD, a DVD, magnetic tape or a video disk. The video encoder and decoder may also be implemented in hardware, software, firmware or any combination thereof.

Additional details about video encoders and decoders to which the invention can be applied are set forth in U.S. provisional patent application Ser. No. 60/449,696 filed Feb. 25, 2003 and Ser. No. 60/482,954 field Jun. 27, 2003 by the same inventor herein and Mihaela Banderschar and entitled “3-D Lifting Structure For SubPixel Accuracy . . . ” and “Video Coding Using Three Dimensional Lifting”, respectively, these applications being incorporated by reference herein in their entirety.

The de-noising algorithm in accordance with the invention will be described with reference to FIG. 1 which shows a video encoder 10 according to one embodiment of the invention. The video encoder 10 includes a wavelet transformer 12 which receives uncompressed video frames from a source thereof (not shown) and transforms the video frames from a spatial domain to a wavelet domain. This transformation spatially decomposes a video frame into multiple two-dimensional bands (Band 1 to Band N) using wavelet filtering, and each band 1, 2, . . . , N for that video frame is represented by a set of wavelet coefficients. The same techniques described below for the encoder 10 are available for use in conjunction with the decoder as well.

The wavelet transformer 12 uses any suitable transform to decompose a video frame into multiple video or wavelet bands. In some embodiments, a frame is decomposed into a first decomposition level that includes a low-low (LL) band, a low-high (LH) band, a high-low (HL) band, and a high-high (HH) band. One or more of these bands may be further decomposed into additional decomposition levels, such as when the LL band is further decomposed into LLLL, LLLH, LLHL, and LLHH sub-bands.

The wavelet bands and/or sub-bands are broken into groups of frames (GOFs) by appropriate software and/or hardware 14 and then provided to a plurality of motion compensated temporal filters (MCTFs) 16₁, . . . , 16_{N}. The MCTFs 16 temporally filter the video bands and remove temporal correlation between the frames to form spatial-temporal sub-bands. For example, the MCTFs 16 may filter the video bands and generate high-pass frames and low-pass frames for each of the video bands. Each MCTF 16 includes a motion estimator 18 and a temporal filter 20. The motion estimators 18 in the MCTFs 16 generate one or more motion vectors, which estimate the amount of motion between a current video frame and a reference frame and produce one or more motion vectors (designated MV). The temporal filters 20 in the MCTFs 16 use this information to temporally filter a group of video frames in the motion direction. The temporally-filtered frames are provided subject to texture coding 22 and then combined into a bitstream.

In addition, the number of frames grouped together and processed by the MCTFs 16 can be adaptively determined for each band. In some embodiments, lower bands have a larger number of frames grouped together, and higher bands have a smaller number of frames grouped together. This allows, for example, the number of frames grouped together per band to be varied based on the characteristics of the sequence of frames or complexity or resiliency requirements. Also, higher spatial frequency bands can be omitted from longer-term temporal filtering. As a particular example, frames in the LL, LH and HL, and HH bands can be placed in groups of eight, four, and two frames, respectively. This allows a maximum decomposition level of three, two, and one, respectively. The number of temporal decomposition levels for each of the bands can be determined using any suitable criteria, such as frame content, a target distortion metric, or a desired level of temporal scalability for each band. As another particular example, frames in each of the LL, LH and HL, and HH bands may be placed in groups of eight frames.

As can be seen from FIG. 1, the order in which the video coder processes the video is first, the spatial domain wavelet transform is performed by wavelet transformer 12 and subsequently, MCTF is applied by the temporal filters 16 for each wavelet band. This differs from conventional interframe wavelet video techniques that apply MCTF on the spatial domain video data and then encode the resulting temporally filtered frames using critical sampled wavelet transforms.

It is a disadvantage though that since the critical-sampled wavelet decomposition is only periodically shift-invariant, the motion estimation and compensation in the wavelet domain is not efficient and coding penalties are observed.

To avoid the inefficiency of motion estimation and compensation in the wavelet domain and the attendant loss of coding efficiency, in accordance with the invention, a low band shifting method (LBS) is used, preferably wherever the de-noising algorithm is applied (at both the video encoder and decoder) to generate shift-invariant motion reference frames. In addition, an interleaving algorithm is used in conjunction with the low band shifting method, as discussed more fully below.

More specifically, in the low band shifting (LBS) method, the wavelet transformer 12 includes or is embodied as a low band shifter which processes the input video frames and generates a full set of wavelet coefficients for all of the possible shifts of one or more of the input bands, i.e., an overcomplete wavelet expansion or representation. This overcomplete representation thus accurately conveys any shift in the spatial domain.

The generation of the overcomplete wavelet expansion of an original image designated 30 by the low band shifter for the low-low (LL) band is shown in FIG. 2. Initially, as shown in FIG. 2, the frame 30 is decomposed into a first decomposition level that includes LL, LH and HL, and HH bands, each of which may be provided to a dedicated MCTF 16. In this example, different shifted wavelet coefficients corresponding to the same decomposition level at a specific spatial location is referred to as “cross-phase wavelet coefficients.”

Each phase of the overcomplete wavelet expansion 24 is generated by shifting the wavelet coefficients of the next-finer level LL band and applying one level wavelet decomposition. For example, wavelet coefficients 32 represent the coefficients of the LL band without shift. Wavelet coefficients 34 represent the coefficients of the LL band after a (1,0) shift, or a shift of one position to the right. Wavelet coefficients 36 represent the coefficients of the LL band after a (0,1) shift, or a shift of one position down. Wavelet coefficients 38 represent the coefficients of the LL band after a (1,1) shift, or a shift of one position to the right and one position down.

Wavelet coefficients 40 represent the coefficients of the HL band without shift. Wavelet coefficients 42 represent the coefficients of the LH band without shift and wavelet coefficients 44 represent the coefficients of the HH band without shift.

One or more of these bands may be further decomposed into additional decomposition levels, such as when the LL band is further decomposed into a second decomposition level including LLLL, LLLH, LLHL, and LLHH sub-bands as shown in FIG. 2. In this case, wavelet coefficients 46 represent the coefficients of the LLLL band without shift, wavelet coefficients 48 represent the coefficients of the LLHL band without shift, wavelet coefficients 50 represent the coefficients of the LLLH band without shift and wavelet coefficients 52 represent the coefficients of the LLHH band without shift.

In a single-level decomposition, the four sets of wavelet coefficients in FIG. 2 would be augmented or combined to generate the overcomplete wavelet expansion 24. However, in view of the additional decomposition of the low-low band, the seven sets of wavelet coefficients 40, 42, 44, 46, 48, 50 and 52 in FIG. 2 would be augmented or combined to generate the unshifted wavelet coefficient of the overcomplete wavelet expansion 24.

FIG. 3 illustrates one example of how wavelet coefficients may be augmented or combined to produce the overcomplete wavelet expansion 24 (for a one-dimensional set of wavelet coefficients). Two exemplifying sets of wavelet coefficients 54, 56 are interleaved to produce a set of overcomplete wavelet coefficients 58. The overcomplete wavelet coefficients 58 represent the overcomplete wavelet expansion 24 shown in FIG. 2. The interleaving is performed such that the new coordinates in the overcomplete wavelet expansion 24 correspond to the associated shift in the original spatial domain. This interleaving technique can also be used recursively at each decomposition level and can be directly extended for 2-D signals. The use of interleaving to generate the overcomplete wavelet coefficients 58 may enable more optimal or optimal sub-pixel accuracy motion estimation and compensation in the video encoder and decoder because it allows consideration of cross-phase dependencies between neighboring wavelet coefficients. Furthermore, the interleaving technique allows the use of adaptive motion estimation techniques known for other types of temporal filtering such as hierarchical variable size block matching, backward motion compensation, and adaptive insertion of intra blocks.

Although FIG. 3 illustrates two sets of wavelet coefficients 54, 56 being interleaved, any number of coefficient sets could be interleaved together to form the overcomplete wavelet coefficients 58, such as seven sets of wavelet coefficients.

With respect to storage requirements, for an n-level decomposition of an input video frame, the overcomplete wavelet representation requires a storage space that is 3n+1 larger than that of the original image.

FIG. 4A shows a 3-D decomposition structure of a conventional MCTF whereas FIG. 4B shows a 3-D decomposition structure for the IBMCTF in accordance with the invention. The interpretation of the decomposition structures will be appreciated by those skilled in the art. As can be seen by a comparison of FIGS. 4A and 4B, in comparison to the 3-D decomposition structure of the conventional MCTF (FIG. 4A), the decomposition structure in accordance with the invention (FIG. 4B) appears non-separable and therefore, it can capture the structure of video sequence more easily. This is partly because a different level of temporal decomposition can be applied for each spatial sub-band depending on the temporal dependency across the frames. This non-separable structure is a very important aspect of the de-noising technique in accordance with the invention because to achieve better performance of de-noising, adaptive processing of the wavelet coefficients depending on the frequency response should be taken into consideration.

Reference is now made to FIGS. 5A and 5B wherein A and B designate previous and current frames, respectively, and a1-a12 and b1-b12 are pixels of these frames, respectively. As a result of the motion estimation procedure, there always exist unconnected pixels which are not filtered in the temporal direction, e.g., pixels a7, a8 as shown in FIG. 5A. Since the unconnected pixels corresponds to the uncovered regions which do not contain new information, the denoising algorithm based on wavelet coefficients processing should be applied only to the connected wavelet coefficients (a1-a6 and a9-a12). Similarly, the noise variance should be also estimated from the spatial HH bands of the temporal H-bands sub-bands excluding the unconnected pixels.

A more advanced denoising technique based on shift-invariant wavelet processing can be implemented in a similar manner using the de-noising algorithm based on IBMCTF.

One simple de-noising algorithm based on IBMCTF can be hard-thresholding which can be formulated as follows

$${{A}^{⋒}}_{i}^{j} ( m , n , t ) = \{ \begin{matrix} {A}_{i}^{j} ( m , n , t ) & if \vert {A}_{i}^{j} ( m , n , t ) \vert > T \\ 0 & otherwise\end{matrix}$$

where [symbol] (m,n,t) denotes the de-noised wavelet coefficients at (m,n) location of the t-frames at the j-th subband of the I-th decomposion level, and Aᵢ^{j}(m,n,t) is the original wavelet coefficients and T denotes the thresholds which can be computed from the noise variance and the sub-band size. For example, the SURE thresholds or Donoho's threshold value can be used as the near minimax optimal thresholding values. For the wavelet domain wiener filter approaches, the denoised estimate of the wavelet coefficients can be obtained as follows:

$${{A}^{⋒}}_{i}^{j} ( m , n , t ) = \frac{{\vert {A}_{i}^{j} ( m , n , t ) \vert}^{2}}{{\vert {A}_{i}^{j} ( m , n , t ) \vert}^{2} + {σ}^{2}} {A}_{i}^{j} ( m , n , t )$$

where σ² denotes the noise variance. Other wavelet denoising algorithms such as Bayesian approaches, MDL, or HMT models can be also used to process the wavelet coefficients from the IBMCTF decomposition.

Although illustrative embodiments of the present invention have been described herein with reference to the accompanying drawings, it is to be understood that the invention is not limited to these precise embodiments, and that various other changes and modifications may be effected therein by one of ordinary skill in the art without departing from the scope or spirit of the invention.

1. A method for de-noising video signals, comprising the steps of:
spatially transforming each frame of video sequences into two-dimensional bands;
decomposing the two-dimensional bands in a temporal direction to form spatial-temporal sub-bands, the step of decomposing the two-dimensional sub-bands comprising the step of applying a low band shifting method to generate shift-invariant motion reference frames; and
eliminating additive noise from each spatial-temporal sub-band.

2. The method of claim 1, wherein the step of decomposing the two-dimensional bands comprises the step of decomposing the two-dimensional bands using a motion-compensated temporal filtering technique for each two-dimensional band.

3. The method of claim 1, wherein the step of eliminating additive noise from each spatial-temporal sub-band comprises the step of using a wavelet de-noising techniques selected from a group consisting of soft-thresholding, hard-thresholding and a wavelet wiener filter.

4. The method of claim 1, wherein the step of spatially transforming each frame comprises the step of applying wavelet filtering.

5. The method of claim 1, wherein the step of applying a low band shifting method to generate shift-invariant motion reference frames comprises the step of generating a full set of wavelet coefficients for all possible shifts of a low-low sub-band.

6. The method of claim 5, further comprising the step of storing the wavelet coefficients by interleaving the wavelet coefficients such that new coordinates in an overcomplete domain correspond to an associated shift in the original spatial domain.

7. The method of claim 6, wherein the wavelet coefficients are interleaved at each decomposition level.

8. A video encoder (10), comprising:
a wavelet transformer (12) for receiving uncompressed video frames from a source thereof and transforming the frames from a spatial domain to a wavelet domain in which two-dimensional bands are represented by a set of wavelet coefficients;
means for breaking the bands into groups of frames (14);
motion compensated temporal filters (16), each receiving the group of frames of a respective one of the bands and temporally filtering the band to remove temporal correlation between the frames; and
means for texture coding (18) the temporally filtered bands, the texture coded, temporally filtered bands being combined into a bitstream.

9. The video encoder (10) of claim 8, wherein said wavelet transformer (12) is arranged to decompose each of the frames into a plurality of decomposition levels.

10. The video encoder (10) of claim 9, wherein a first one of the decomposition levels includes a low-low (LL) band, a low-high (LH) band, a high-low (HL) band, and a high-high (HH) band, and a second one of the decomposition levels includes decompositions of the LL band into LLLL (low-low, low-low), LLLH (low-low, low-high), LLHL (low-low, high-low) and LLHH (low-low, high-high) sub-bands.

11. The video encoder (10) of claim 8, wherein said motion compensated temporal filters (16) are arranged to filter the bands and generate high-pass frames and low-pass frames for each of the bands.

12. The video encoder (10) of claim 8, wherein each of said motion compensated temporal filters (16) includes a motion estimator (18) for generating at least one motion vector and a temporal filter (20) for receiving the at least one motion vector and temporally filtering a group of frames in the motion direction based thereon.

13. The video encoder (10) of claim 8, wherein said wavelet transformer (12) is arranged to apply a low band shifting method in which a full set of wavelet coefficients is generated for all possible shifts of one or more of the input bands to thereby accurately convey any shift in the spatial domain.

14. The video encoder (10) of claim 13, wherein said wavelet transformer (12) is arranged to generate the full set of wavelet coefficients by shifting the wavelet coefficients of the next-finer level LL band and applying one level wavelet decomposition, the wavelet coefficients generated during the decomposition then being combined to generate the full set of wavelet coefficients.

15. The video encoder (10) of claim 14, wherein said wavelet transformer (12) is arranged to interleave the wavelet coefficients generated during the decomposition in order to generate the full set of wavelet coefficients.
